(19) United States
(12) Patent Application Publication
(10) Pub. No.: US 2026/0025549 A1
(43) Pub. Date: Jan. 22, 2026

(54) METHOD, APPARATUS, DEVICE AND STORAGE MEDIUM FOR CONTENT INTERACTION

(71) Applicant: Beijing Zitiao Network Technology Co., Ltd., Beijing (CN)

(72) Inventors: Zilong Wang, Beijing (CN); Yueyue Xiong, Beijing (CN); Yiru Chen, Beijing (CN)

(21) Appl. No.: 19/276,635

(22) Filed: Jul. 22, 2025

(30) Foreign Application Priority Data
Jul. 22, 2024 (WO) PCT/CN2024/106860

(51) Int. Cl. H04N 21/4363; H04N 21/442

(52) U.S. Cl. CPC H04N 21/43637; H04N 21/44222

(57) ABSTRACT

A method for content interaction is provided. The method include establishing, at a first terminal device corresponding to a first user of an application, a near field communication connection between the first terminal device and a second terminal device corresponding to a second user of the application in response to a detection of a content transfer request for the second user; presenting a content transfer panel, the content transfer panel presenting a media content list cached by the application at the first terminal device; and transmitting one or more items of media content from the first terminal device to the second terminal device via the near field communication connection in response to receiving a selection of the one or more items of media content in the media content list.

### CROSS REFERENCE

The present application claims priority to PCT Patent Application PCT/CN2024/106860, filed on Jul. 22, 2024, and entitled “Method, Apparatus, Device, and Storage Medium for Content Interaction”, the entirety of which is incorporated herein by reference.

### FIELD

Embodiments of the present disclosure generally relate to the field of computers, and more specifically to a method, apparatus, device, and computer-readable storage medium for content interaction.

### BACKGROUND

Nowadays, more and more applications are designed to provide various services to users. For example, users can create, browse, comment on, and forward various types of content in the application, including various media content such as videos, images, image collections, and audio. In addition, these applications also support interaction with users to facilitate users to browse various media content. When playing content for users to browse, it is expected that the interactive mode that is more convenient for users to browse the content.

### SUMMARY

In a first aspect of the disclosure, a method for content interaction is provided, the method includes establishing, at a first terminal device corresponding to a first user of an application, a near field communication connection between the first terminal device and a second terminal device corresponding to a second user of the application in response to a detection of a content transfer request for the second user; presenting a content transfer panel, the content transfer panel presenting a media content list cached by the application at the first terminal device; and transmitting one or more items of media content from the first terminal device to the second terminal device via the near field communication connection in response to receiving a selection of the one or more items of media content in the media content list.

In a second aspect the disclosure, a method for content interaction is provided, the method includes establishing, at a second terminal device corresponding to a second user of an application, a near field communication connection between the second terminal device and a first terminal device; receiving, via the near field communication connection, one or more items of media content from the first terminal device, the one or more items of media content being cached at the first terminal device; and playing at least one of the received one or more items of media content in response to a detection of a content viewing request for cached content.

In a third aspect of the disclosure, an apparatus for content interaction is provided. The apparatus includes: a connection establishment module configured to establish, at a first terminal device corresponding to a first user of an application, a near field communication connection between the first terminal device and a second terminal device corresponding to a second user of the application in response to a detection of a content transfer request for the second user; a panel presenting module configured to present a content transfer panel, the content transfer panel presenting a media content list cached by the application at the first terminal device; and a media content transfer module configured to one or more items of media content from the first terminal device to the second terminal device via the near field communication connection in response to receiving a selection of the one or more items of the media content in the media content list.

In a fourth aspect of the disclosure, an apparatus for content interaction is provided. The apparatus includes a connection establishment module configured to establish, at a second terminal device corresponding to a second user of an application, a near field communication connection between the second terminal device and a first terminal device; a media content receiving module configured to receive, via the near field communication connection, one or more items of media content from the first terminal device, the one or more items of media content being cached at the first terminal device; and a media content playing module configured to play at least one of the received one or more items of media content in response to a detection of a content viewing request for cached content.

In a fifth aspect of the disclosure, an electronic device is provided. The electronic device includes at least one processing unit; and at least one memory coupled to the at least one processing unit and storing instructions for execution by the at least one processing unit, the instructions, when executed by the at least one processing unit, causing the electronic device to implement the method according to the first and second aspect of the disclosure.

In a sixth aspect of the disclosure, a non-transitory computer-readable storage medium is provided, the non-transitory computer-readable storage medium having a computer program stored thereon which, when executed by a processor, causes the processor to implement the method according to the first and second aspect of the disclosure.

In a seventh aspect of the disclosure, a computer program product including computer program is provided, where the computer program, when executed by a processor, implements the method according to the first and second aspect of the disclosure.

It should be understood that the content described in the summary are not intended to limit the key features or important features of the implementation of the present disclosure, nor are they intended to limit the scope of the present disclosure. Other features of the present disclosure will become easier to understand through the following description.

### BRIEF DESCRIPTION OF DRAWINGS

The above and other features, advantages and aspects of various implementations of the present disclosure will become more apparent hereinafter in conjunction with the accompanying drawings and with reference to the following detailed description. In the accompanying drawings, the same or similar figure labels represent the same or similar elements, where

FIG. 1 is a schematic diagram of an example environment in which embodiments of the present disclosure may be implemented;

FIG. 2 is a schematic diagram of a process for content interaction according to some embodiments of the present disclosure;

FIGS. 3A-3G are schematic diagrams of an example interface for content interaction at a first terminal device according to some embodiments of the present disclosure;

FIGS. 4A-4D are schematic diagrams of an example interface for content interaction at a second terminal device according to some embodiments of the present disclosure;

FIG. 4E is a schematic diagram of an example interface for content interaction at a first terminal device and a second terminal device according to some embodiments of the present disclosure;

FIGS. 5A-5D are schematic diagrams of an example interface for presenting a user selection panel according to some embodiments of the present disclosure;

FIGS. 6A-6F are schematic diagrams of an example interface for content interaction according to some embodiments of the present disclosure;

FIGS. 7A-7C are schematic diagrams of an example interface for presenting a flow saving mode function page according to some embodiments of the present disclosure;

FIGS. 8A-8C are schematic diagrams of example interfaces for content interaction based on a predetermined page according to some embodiments of the present disclosure;

FIG. 9A is a flowchart of an example process for content interaction at a first terminal device according to some embodiments of the present disclosure;

FIG. 9B is a flowchart of an example process for content interaction at a second terminal device according to some embodiments of the present disclosure;

FIG. 10A is a schematic structural block diagram of an apparatus for content interaction at a first terminal device according to some embodiments of the present disclosure;

FIG. 10B is a schematic structural block diagram of an apparatus for content interaction at a second terminal device according to some embodiments of the present disclosure; and

FIG. 11 is a block diagram of an electronic device in which one or more embodiments of the present disclosure may be implemented.

### DETAILED DESCRIPTION

Embodiments of the present disclosure will be described in more details in below with reference to the accompanying drawings. Although certain embodiments of the present disclosure are shown in the accompanying drawings, it should be understood that the present disclosure may be implemented in various forms and should not be construed as being limited to the embodiments described herein. On the contrary, these embodiments are provided to provide a more thorough and complete understanding of the present disclosure. It should be understood that the drawings and embodiments of the present disclosure are for illustrative purposes only and are not intended to limit the scope of protection of the present disclosure.

In the description of the embodiments of the present disclosure, the term “including” and similar terms should be understood as open inclusions, i.e., “including but not limited to”. The term “based on” should be understood as “based at least in part on”. The term “one embodiment” or “the embodiment” should be understood as “at least one embodiment”. The term “some embodiments” should be understood as “at least some embodiments”. Other explicit and implicit definitions may also be included below.

In this document, unless explicitly stated otherwise, performing a step “in response to A” does not mean performing the step immediately after “A” but may include one or more intermediate steps.

It is understood that the data involved in this technical solution (including but not limited to the data itself, the acquisition or use of the data) shall comply with the requirements of relevant laws, regulations and relevant provisions.

It is understood that before using the technical solutions disclosed in each embodiment of this disclosure, the type, scope of use, usage scenarios, etc. of the personal information involved in this disclosure shall be informed to the user in an appropriate manner in accordance with relevant laws and regulations and the user's authorization shall be obtained.

For example, in response to receiving an active request from a user, a prompt message is sent to the user to clearly prompt the user that the operation requested to be performed will require obtaining and using the user's personal information, so that the user can independently choose whether to provide personal information to the electronic device, application, server or storage medium or other software or hardware that executes the operation of the technical solutions of the present disclosure based on the prompt message.

As an optional but non-limiting implementation, in response to receiving an active request from a user, a prompt message is sent to the user, for example, in the form of a pop-up window, in which the prompt message can be presented in text format. In addition, the pop-up window can also carry a selection control for the user to choose “agree” or “disagree” to provide personal information to the electronic device.

It can be understood that the above notification and the process of obtaining user authorization are only illustrative and do not constitute a limitation on the implementation of the present disclosure. Other methods that meet relevant laws and regulations can also be applied to the implementation of the present disclosure.

As briefly described above, users can create, browse, comment on, and forward various types of content in the application, including various media content such as videos, images, image collections, and audio. However, all media content that users currently watch in the application must be downloaded using data traffic. For example, if a piece of media content (e.g., a video) is played by 100 terminal devices corresponding to different users, the media content needs to be downloaded 100 times, consuming the data traffic corresponding to 100 copies of the media content.

In view of this, an embodiment of the present disclosure provides an improved solution for content interaction. In this solution, at a first terminal device corresponding to a first user of an application, if a content transfer request for a second user of the application is detected, a near field communication connection is established between the first terminal device and a second terminal device corresponding to the second user. After the near field communication connection is established, the first terminal device presents a content transfer panel, which presents a media content list cached by the application at the first terminal device. If a selection of one or more items of the media content in the media content list are received, the one or more items of the media content are transmitted from the first terminal device to the second terminal device via the near field communication connection. Thus, cached media content can be transmitted between users based on the near field communication connection, thereby enabling users to view media content without using data traffic.

The term “work” in the present disclosure refers to any type of media content or media work, which includes one or more types of content, including but not limited to audio files, video files, image files, text files, etc. Specifically, the work can be short videos, music, pictures, picture collections, multimedia clips, audio-visual materials, etc. The present disclosure is not limited in this respect.

### Example Environment

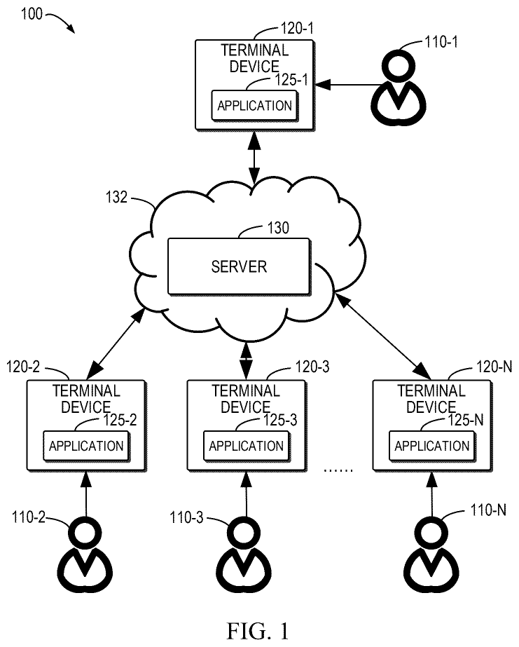

FIG. 1 shows a schematic diagram of an example environment 100 in which embodiments of the present disclosure may be implemented. Environment 100 includes one or more users 110-1, 110-2, 110-3, . . . , 110-N that can send and receive messages through their associated terminal devices 120-1, 120-2, 120-3, . . . , 120-N. For ease of discussion, users 110-1, 110-2, 110-3, . . . , 110-N can be collectively or individually referred to as user 110, and terminal devices 120-1, 120-2, 120-3, . . . , 120-N can be collectively or individually referred to as terminal device 120. In some scenarios, user 110 can browse, watch, publish, and comment on various types of media content in a target platform through associated terminal device 120. These media content sometimes is also referred to as works. In some scenarios, user 110 is also referred to as the publisher of the work. In this article, “media content” can be content in various forms, including video, audio, image, image collection, text, work combining image and text, etc.

The terminal device 120 may be installed with an application 125 supporting message interaction (i.e., the terminal device 120-1 may be installed with application 125-1, the terminal device 120-2 may be installed with application 125-2, the terminal device 120-3 may be installed with application 125-3, . . . , the terminal device 120-N may be installed with application 125-N). It should be noted that the applications 125 installed in different terminal devices 120 may be completely the same applications or different applications (e.g., different versions). The application 125 may be any appropriate application with message sending and receiving functions, such as a dedicated chat application, a social application, a content sharing application, an office support application, etc.

In the environment 100 of FIG. 1, if the application 125 is in an active state, the terminal device 120 may present the user interface of the application 125. This user interface may include various interfaces that the application 125 may provide, such as a user interface that supports content interaction, a user interface that supports message interaction, a user interface that supports content browsing, a message sending and receiving interface, and the like. Through different user interfaces, the application 125 may provide different content to the user 110. Through appropriate means, such as clicking or selecting any appropriate element in the user interface, the application 125 may also provide the user 110 with the selection and switching of the presentation mode of the associated content.

In some embodiments, different terminal devices 120 can also communicate with the server 130 through the network 132 to provide message interaction services. The server 130 can provide management, configuration and maintenance functions for the application 125.

The terminal device 120 can be any type of mobile terminal, fixed terminal or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a television receiver, a radio receiver, an e-book device, a gaming device or any combination of the foregoing, including accessories and peripherals of these devices or any combination thereof. In some embodiments, the terminal device 120 can also support any type of interface for the user (such as a “wearable” circuit, etc.). The server 130 can be any type of computing system/server that can provide computing power, including but not limited to a mainframe, an edge computing node, a computing device in a cloud environment, etc.

It should be understood that the structure and function of each element in environment 100 are described for example purposes only and do not imply any limitation on the scope of the present disclosure.

Some example embodiments of the present disclosure are described below with reference to the accompanying drawings. It should be understood that the pages shown in the accompanying drawings are merely examples, and various page designs may actually exist. The various graphical elements in the page may have different arrangements and different visual representations, one or more of the elements may be omitted or replaced, and one or more other elements may also exist. The embodiments of the present disclosure are not limited in this respect. In addition, in the following, for ease of discussion, the example embodiments will be mainly described with respect to terminal device 120-1 (also referred to as the sending end) and terminal device 120-2 (also referred to as the receiving end). It should be understood that the actions described with respect to terminal device 120-1 and terminal device 120-2 may be performed by applications on terminal device 120-1 and terminal device 120-2, or may be performed by the application in collaboration with its service end (e.g., server 130).

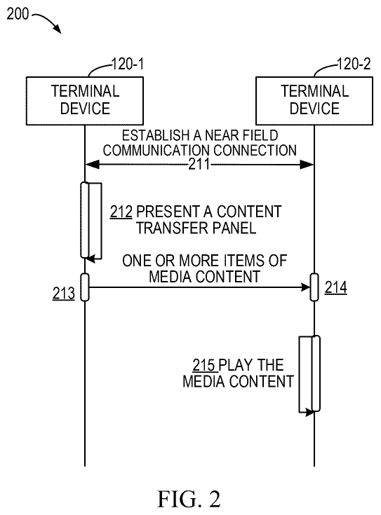

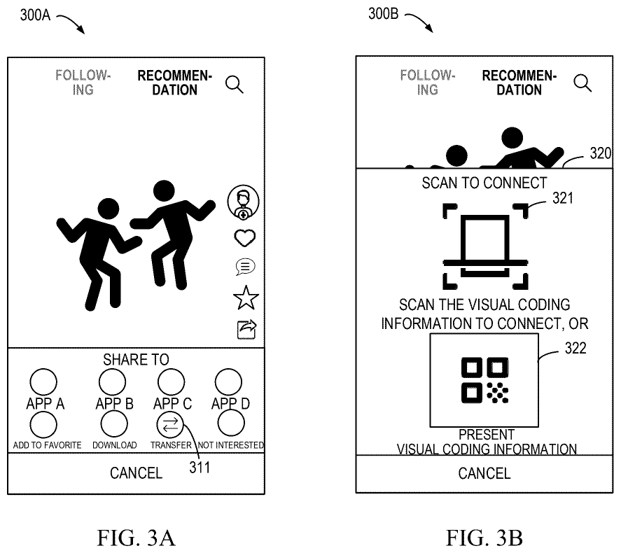

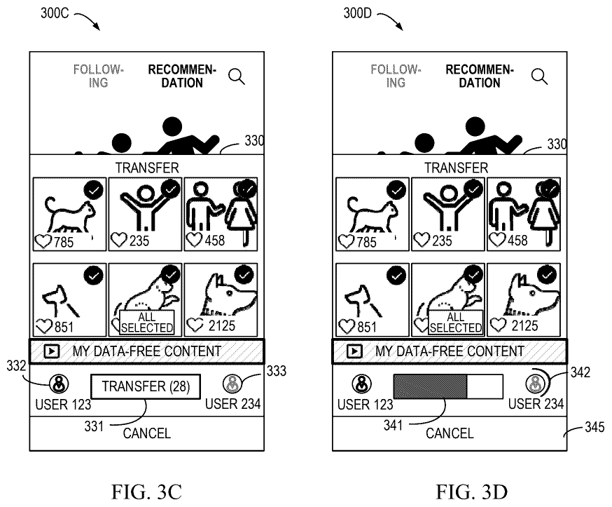

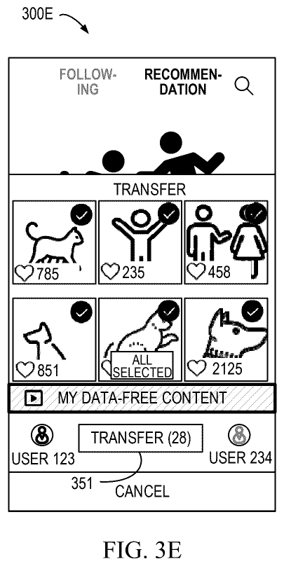

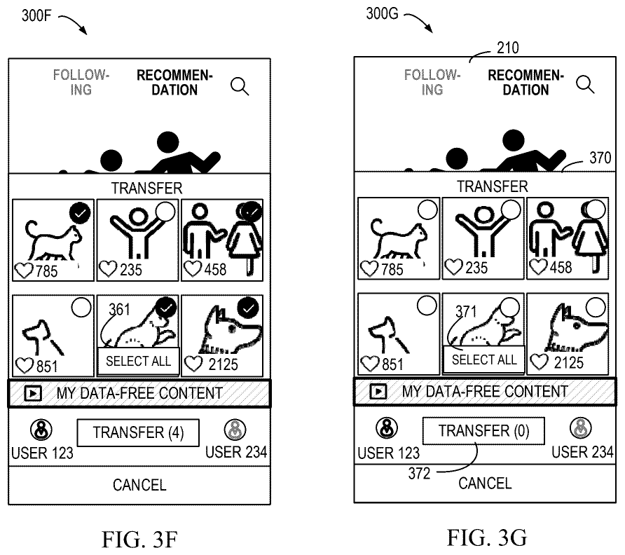

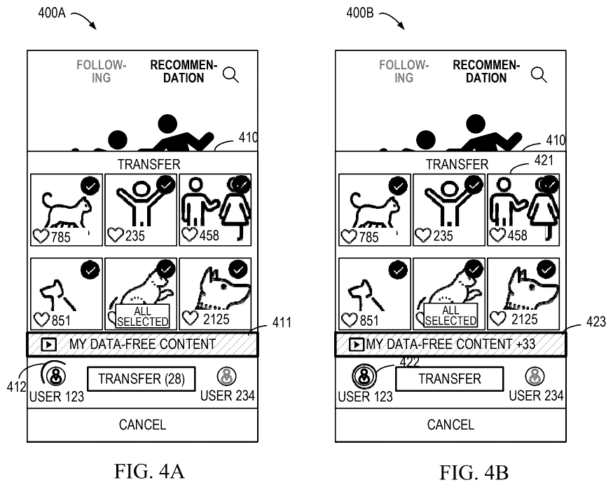

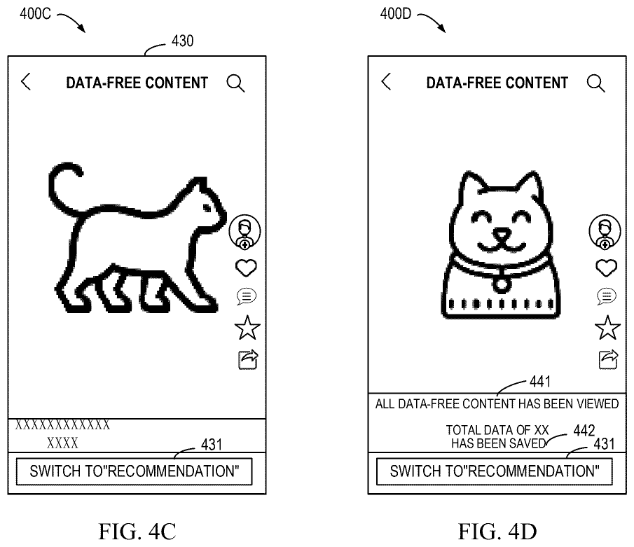

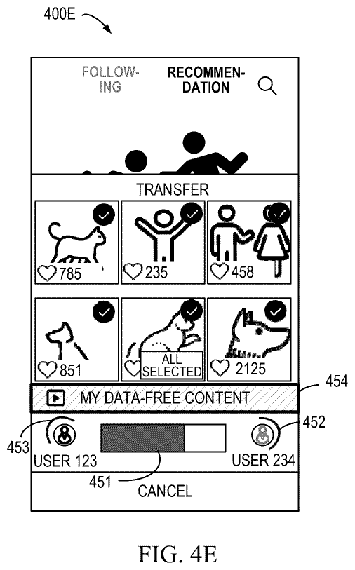

The following will describe the process for content interaction of the present disclosure with reference to FIG. 2, FIGS. 3A-3G, and FIGS. 4A-4D. FIG. 2 shows a schematic diagram of a process 200 for content interaction according to some embodiments of the present disclosure. Process 200 may be implemented at a terminal device 120. Process 200 is described below with reference to FIG. 1. FIG. 3A-3G show schematic diagrams of example interfaces 300A to 300G for content interaction at a terminal device as a content transmitter according to some embodiments of the present disclosure; FIG. 4A-4D show schematic diagrams of example interfaces 400A to 400D for content interaction at a terminal device as a content receiver according to some embodiments of the present disclosure.

In some embodiments, if a first terminal device corresponding to a first user of an application detects a content transfer request for a second user of the application, a near field communication connection is established between the first terminal device and a second terminal device corresponding to the second user. In the process 200, if a terminal device 120-1 corresponding to a user 110-1 (also referred to as a sender) of an application 125 detects a content transfer request for a user 110-2 (also referred to as a receiver) of the application 125, the terminal device 120-1 establishes (211) a near field communication connection with a terminal device 120-2 corresponding to the user 110-2. In some embodiments, the near field communication connection indicates that devices can be directly connected, and content can be transmitted through Bluetooth or WI-FI direct connection. In some embodiments, the transmission between devices does not consume the data traffic of the user's operator, that is, the transmission process is free.

In some embodiments, the terminal device may detect the content transfer request for the second user in the following manner. If the terminal device 120-1 detects the triggering of the content transfer entry, the user selection panel is presented. Then, the terminal device 120-1 detects the content transfer request for the second user via the user selection panel. In some embodiments, the user selection panel may include at least one of the following: a scanning window for scanning the visual coding information, the first visual coding information corresponding to the first user, and the user identification of one or more users in the application.

In some examples, the terminal device 120-1 can scan the visual coding information of the user 110-2 through the scanning window included in the user selection panel to detect the content transfer request for the user 110-2, thereby establishing a near field communication connection between the terminal device 120-1 and the terminal device 120-2. The visual coding information indicates information that can be used to uniquely identify the user or the terminal device. For example, the visual coding information can be a QR code, a barcode, etc.

In the example interfaces 300A to 300B shown in FIGS. 3A-3B, if the terminal device 120-1 detects that the user 110-1 triggers the content transfer entry 311, the user selection panel 320 is presented. The terminal device 120-1 may present a scanning window 321 in the user selection panel 320. The user 110-1 may use the terminal device 110-1 to scan the visual coding information of the user 110-2, thereby establishing a near field communication connection between the terminal device 120-1 and the terminal device 120-2.

In some examples, the terminal device 120-1 may also detect a content transfer request for the user 120-2 through the visual coding information of the user 110-1 included in the user selection panel, thereby establishing a near field communication connection between the terminal device 120-1 and the terminal device 120-2. As shown in the example interfaces 300A to 300B in FIGS. 3A-3B, if the terminal device 120-1 detects that the user 110-1 triggers the content transfer entry 311, the user selection panel 320 is presented. The terminal device 120-1 can present the visual coding information of the user 110-1 in the user selection panel 320. The user 110-2 can scan the visual coding information of the user 110-1 by using the terminal device 120-2, thereby establishing a near field communication connection between the terminal device 120-1 and the terminal device 120-2.

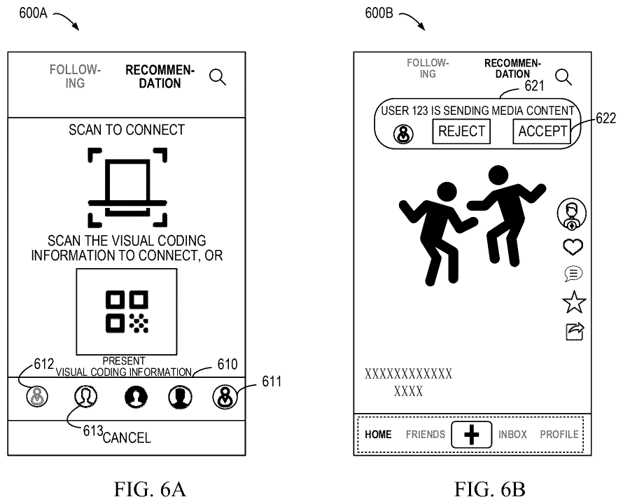

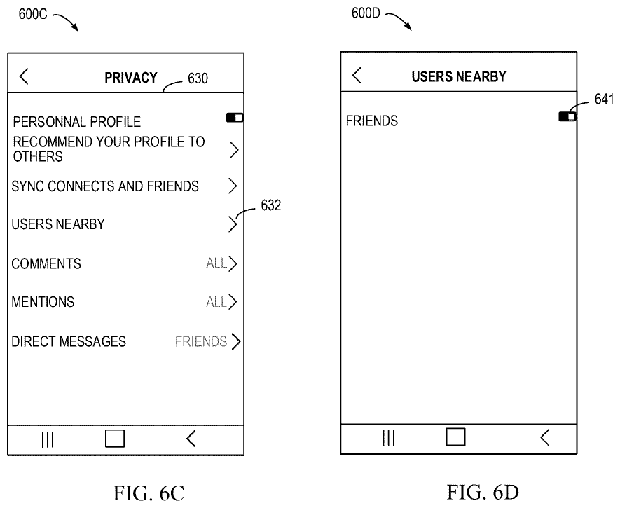

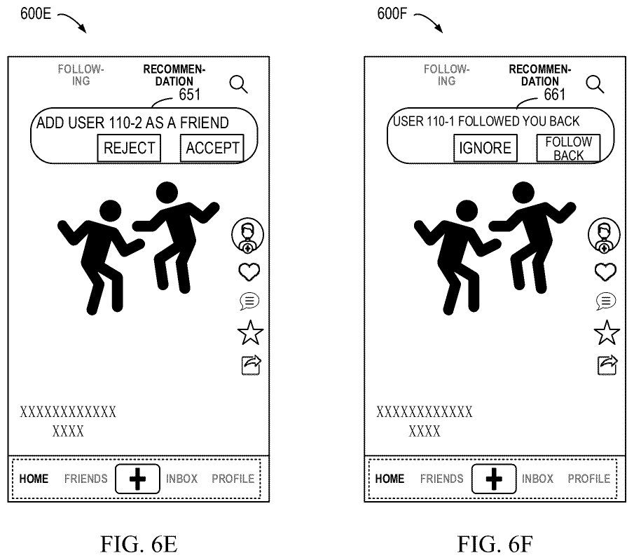

In some other examples, the terminal device 120-1 may also detect a content transfer request for the user 120-2 through the user identification included in the user selection panel, thereby establishing a near field communication connection between the terminal device 120-1 and the terminal device 120-2. The terminal device 120-1 may also detect a content transfer request for the user 120-2 through the user identification included in the user selection panel, which will be described in detail below with reference to FIGS. 6A-6F.

In some embodiments, the first terminal device presents a content transfer panel. The content transfer panel presents a media content list cached by the application at the first terminal device. In the process 200, the terminal device 120-1 presents (212) a content transfer panel. The terminal device 120-1 presents a media content list cached by the application at the terminal device 120-1 in the content transfer panel. In some examples, the media content list may include one or more items of the media content cached at the terminal device 120-1, such as videos, images, image sets, works (e.g., graphic works), etc. The media content cached by each application at the terminal device may be content that is partially or completely played at the terminal device or cached in other ways. The terminal device 120-1 may need to consume a certain amount of data traffic to cache the media content locally.

As shown in the example interface 300C of FIG. 3C, after the terminal device 120-1 establishes a near field communication connection with the terminal device 120-2, the terminal device 120-1 presents a content transfer panel 330. The media content list presented in the content transfer panel 330 is: a media content list cached by the user 110-1 at the terminal device 120-1 for the application. It should be understood that any media content in the media content list cached by the user 110-1 at the terminal device 120-1 indicates a media content of the application 125 that the user 110-1 has browsed.

In some embodiments, if the first terminal device receives a selection of one or more items of the media content in the media content list, the one or more items of the media content are transmitted from the first terminal device to the second terminal device via the near field communication connection. In the process 200, if the user 110-1 selects one or more items of the media content from the content media list, the terminal device 120-1 transmits (213) the selected one or more media content to the terminal device 120-2.

As shown in the example interface 300C of FIG. 3C, the user 110-1 can select one or more items of the media content from the content media list presented in the content transfer panel 330. Then, if the terminal device 120-1 detects that the user 110-1 clicks the transmission control 331, the selected one or more items of the media content are transmitted to the terminal device 120-2.

In some embodiments, the second terminal device receives one or more items of the media content from the first terminal device via a near field communication connection. The one or more items of the media content received by the second terminal device is cached at the first terminal device. In the process 200, the terminal device 120-2 receives (214) one or more items of the media content that have been cached at the terminal device 120-1 from the terminal device 120-1 via a near field communication connection. In this way, the terminal device can quickly obtain the media content that has been cached in other terminal devices for viewing via a near field communication connection (for example, a Wi-Fi direct connection or other methods) without consuming the local network traffic. In this article, the user or terminal device that sends the media content can be referred to as the sender of the content, and the user or terminal device that receives the media content can be referred to as the receiver of the content.

As shown in FIGS. 3C and 4B, when the user 110-1 clicks the transfer control 331 to transfer one or more selected items of the media content to the terminal device 120-2, the terminal device 120-2 receives the one or more items of the media content that have been cached at the terminal device 120-1 from the terminal device 120-1 via the near field communication connection.

In some embodiments, if the second terminal device detects a content viewing request for the cached content, it plays at least one of the received one or more items of the media content. In the process 200, if the terminal device 120-2 detects a content viewing request for the cached content by the user 110-2, it plays (215) at least one of the received one or more items of the media content.

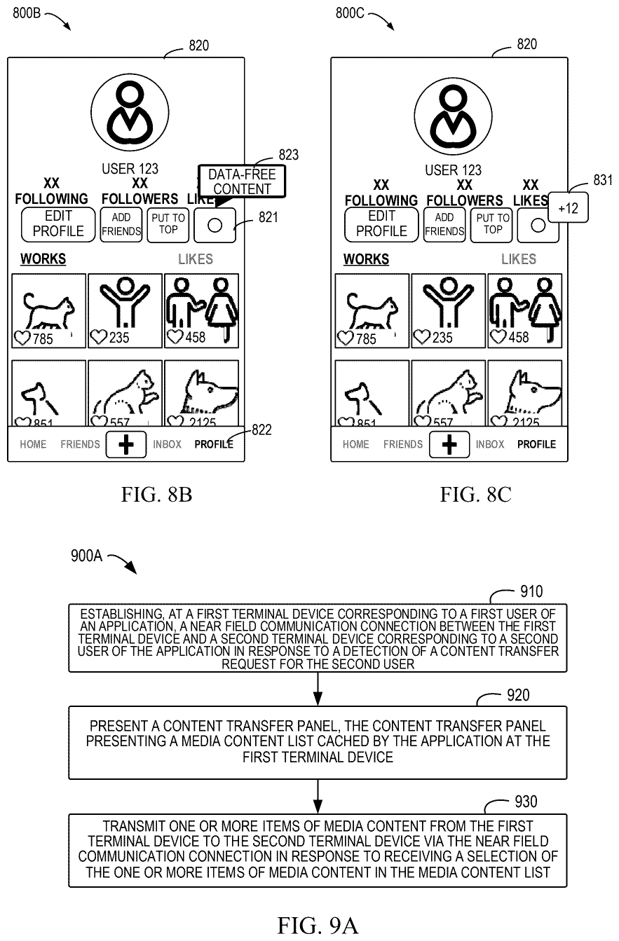

The request to view the cached content may be triggered in a variety of ways. In some examples, if the terminal device 120-2 detects that the user 110-2 clicks on the cached view entry, it plays (215) at least one of the received one or more items of the media content. In some examples, the cached view entry may be presented in a different page associated with the application. The following will describe in detail, with reference to FIG. 4B and FIGS. 8A-8C, how the terminal device detects a content viewing request based on the triggering of the cached view entry.

As shown in the example interfaces 400B to 400C of FIGS. 4B-4C, the user 110-2 can click on the cache viewing entry (sometimes also referred to as the “my data-free content” entry) 411 to view at least one of the received one or more items of the media content. After the terminal device 120-2 detects that the user 110-2 clicks on the cache viewing entry 411, the “traffic-free content” page 430 is presented for the user 110-2 to browse the media content received from the terminal device 120-1 without using data traffic.

Thus, cached media content can be transmitted between users through near field communication connections, so that users can view media content without using data traffic. For ease of understanding, the following will first describe the content interaction solution of the present disclosure from the perspective of the terminal device 120-1 (i.e., the content transfer party).

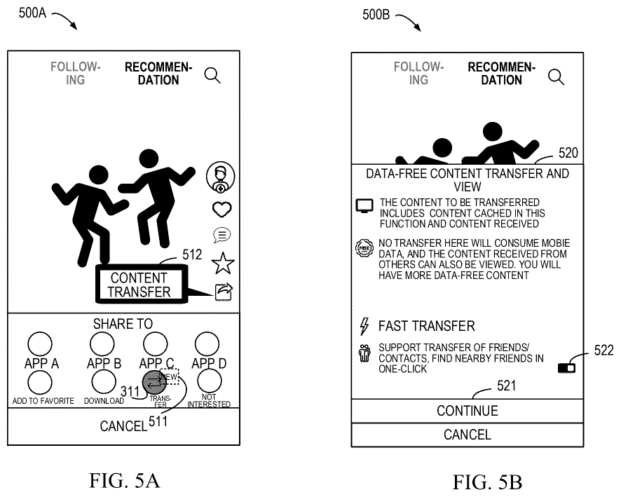

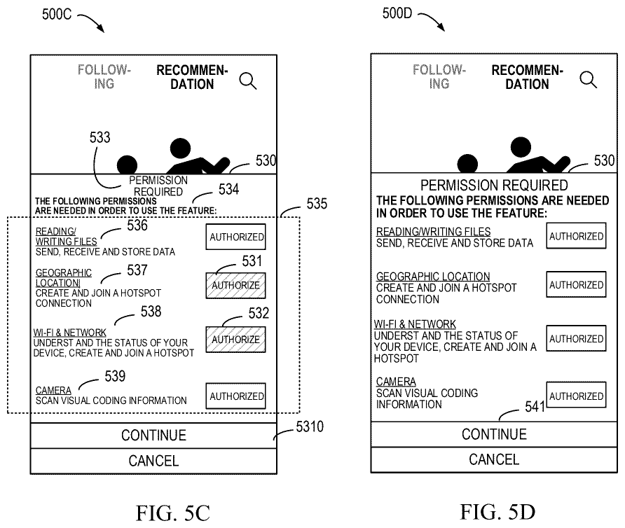

In some embodiments, the terminal device 120-1 can detect the content transfer request for the user 110-2 via the user selection panel, and then establish a near field communication connection between the terminal device 120-1 and the terminal device 120-2. Therefore, for ease of understanding, the following first describes the presentation of the user selection panel by the terminal device with reference to FIGS. 5A-5D. FIGS. 5A-5D show schematic diagrams of example interfaces 500A to 500D for presenting a user selection panel according to some embodiments of the present disclosure.

In some embodiments, if the terminal device 120-1 detects a trigger for the content transfer entry, it determines whether to obtain one or more permissions to use one or more functions in the terminal device 120-1. The one or more functions include the functions required for the terminal device 120-1 to support the transmission and reception of media content via a near field communication connection. In some embodiments, the one or more functions may include at least one of the following: a function for reading and writing files, a function for supporting near field communication, and a camera function. In some examples, the function indication for supporting near field communication includes Wi-Fi and network permissions. Some devices or operating systems may require geographic location permissions to support near field communication connections. It should be understood that some example functions are given here. In other applications or scenarios, if the near field communication connection requires more or fewer functions, the user may be requested to obtain one or more permissions for the corresponding functions before establishing the near field communication connection.

In the example interface 500A shown in FIG. 5A, if the terminal device 120-1 detects that the user 110-1 triggers the content transfer entry 311, it determines whether the terminal device 120-1 has obtained the one or more permissions to use one or more functions in the terminal device 120-1. In some examples, for the content transfer entry 311 that has not been clicked, the terminal device 120-1 will present a new function guide style 511 (for example, displaying the word “new”) in the area associated with the content transfer entry 311. In some examples, the content transfer entry can be presented in the sharing panel or in the setting page. The present disclosure is not limited to this.

In some embodiments, if the terminal device 120-1 determines that it does not obtain a permission to use at least one of the one or more functions, the terminal device 120-1 presents an authorization panel. The authorization panel at least indicates an enabling control for the permission to use the at least one function. In some examples, if the terminal device 120-1 determines that it does not obtain the permissions to use any of the one or more functions, the enabling control for enabling the function permission can be reused.

As shown in the example interfaces 500A to 500D of FIGS. 5B-5D, if the terminal device 120-1 detects that the user 110-1 clicks on the content transfer entry 311 and determines that the user 110-1 has not fully authorized the use for the function, it can present a function introduction panel 520 about data-free content transfer and viewing. The function introduction panel 520 may include an introduction to the content that can be transmitted, such as the content cached at the terminal device 120-1, and the received content, etc. The function introduction panel 520 may include an introduction to the data-free content transfer and viewing, such as all transmissions are conducted without using mobile data, and the received content can be viewed without data traffic as well, etc. The function introduction panel 520 may include an introduction to content transfer speed, such as fast transmission. The function introduction panel 520 may also include an introduction to transmission between contacts, such as the user 110-1 can click on the control 522 to turn on or off transmission between contacts.

Next, if the terminal device 120-1 detects that the user 110-1 clicks the “Continue” control 521, the authorization panel 530 is presented to guide the user 110-1 to execute the authorization operation. The authorization panel 530 includes a title 533, a subtitle 534, a permission module 535, and the like. The permission module 535 includes read-write permissions 536, geographic location permissions 537, Wi-Fi and network permissions 538, camera permissions 539, and the like. The permission module 535 also includes the usage scenario and purpose of each permission, and the corresponding enabling controls for authorization for each permission. In some examples, the terminal device 120-1 may gray out the corresponding enabling controls for the authorized permissions, that is, in an unclickable state. In some examples, the terminal device 120-1 sets the corresponding enabling controls for the unauthorized permissions to a clickable state for the user 110-1 to authorize. For example, for the unauthorized geographic location permission 537, the terminal device 120-1 will present its corresponding enabling control 531. For unauthorized Wi-Fi and network permissions 538, the terminal device 120-1 will present the corresponding enablement control 532. In some examples, if the Wi-Fi and network permissions 538 have been authorized, but the Wi-Fi is not turned on, the terminal device 120-1 will display a prompt message of “Turn on Wi-Fi”.

In some embodiments, if the terminal device 110-1 determines the authorization of one or more functions, it presents a user selection panel. As shown in FIG. 5C, if at least one function among the one or more functions are not authorized, the terminal device 120-1 grays out the “Continue” control 5310 and makes it unclickable. As shown in FIG. 5D, if all functions among the one or more functions are authorized, the terminal device 110 receives a control trigger for the “Continue” control 541 and presents a user selection page.

In some embodiments, if the terminal device 120-1 detects that the user 110-1 triggers the content transfer entry and determines that the one or more functions are authorized, it can present a user selection panel including a scanning window and the visual coding information of the user 110-1. In some embodiments, if the terminal device 120-1 detects that the user 110-1 triggers the content transfer entry and determines that the one or more functions are authorized, it can also present a user selection panel including a scanning window, the visual coding information of the user 110-1, and the user identification of one or more users in the application.

The following will describe in detail the user identification included in the user selection panel of the terminal device 120-1 to detect the content transfer request for the user 120-2 with reference to FIGS. 6A-6F. FIGS. 6A-6F are schematic diagrams of example interfaces 600A to 600F for content interaction according to some embodiments of the present disclosure.

In some embodiments, the terminal device 120-1 determines one or more terminal devices within its predetermined geographic range. one or more terminal devices are configured with permissions to be discovered by surrounding devices. In some embodiments, the size of the predetermined geographic range may depend on a neighboring device discovery protocol and/or user settings (for example, a user may select the size of the geographic range within which the device can be discovered).

As shown in the example interfaces 600C to 600D of FIGS. 6C-6D, if the terminal device detects that the user clicks on the entry 632 corresponding to the discovery of nearby users in the user privacy setting panel 630, a control 641 for enabling the permission to be discovered by surrounding devices is presented. For example, if the permission to be discovered by surrounding devices in the terminal device 120-2 is configured to be enabled by the user 110-2, the terminal device 120-1 can determine the terminal device 120-2 that is within its predetermined geographical range.

Then, the terminal device 120-1 may present the user identification of one or more users corresponding to the one or more terminal devices in the user selection panel. In the example interface 600A shown in FIG. 6A, in the scenario where the terminal device 120-1 determines that one or more terminal devices are located within its predetermined geographical range, the terminal device 120-1 may present the user identification 611 of the user 123, the user identification 612 of the user 234, the user identification 612 of the user C, and so on, corresponding to the one or more terminal devices in the user selection panel. In some embodiments, if one or more user identifications exceed the displayable range of the area 610 included in the user selection panel, the user may slide horizontally to view more user identifications.

In some embodiments, if the terminal device 120-1 determines that the first user and the second user have not established a predetermined social relationship, a prompt message is provided to indicate that the first user initiates the establishment of a predetermined social relationship with the second user. It should be understood that from the perspective of user 110-1, after the near field communication connection between the terminal device 120-1 and the terminal device 120-2 is established, if the user 110-1 and the user 110-2 have not established a predetermined social relationship, the terminal device 120-1 provides prompt information to the user 110-1. As shown in the example interface 600E of FIG. 6E, the terminal device 120-1 provides the user 110-1 with a prompt message 651 “Add user 110-2 as a friend”.

In some embodiments, if the terminal device 120-2 determines that the second user and the first user have not established a predetermined social relationship, a prompt message is provided to indicate that the second user initiates the establishment of a predetermined social relationship with the first user. It should be understood that, from the perspective of user 110-2, after the near field communication connection between terminal device 120-1 and terminal device 120-2 is established, if user 110-1 and user 110-2 have not established a predetermined social relationship, terminal device 120-2 provides prompt information to user 110-2. As shown in the example interface 600F of FIG. 6F, terminal device 120-2 provides prompt information 661 “user 110-1 has followed you” to user 110-2.

In some embodiments, user 110-1 can use terminal device 120-1 to scan the visual coding information corresponding to user 110-2, user 110-2 can use terminal device 120-2 to scan the visual coding information of user 110-1, or user 110-1 can establish a near field communication connection between terminal device 120-1 and terminal device 120-2 by clicking on the user identification of user 110-1. After the terminal device 120-1 establishes a near field communication connection with the terminal device 120-2, the terminal device 120-1 presents a content transfer panel.

In some embodiments, the terminal device 120-1 may determine the media content list to be presented in the content transfer panel from the media content set cached by the application at the first terminal device according to at least one of the following: accessibilities of respective items of the media content in the media content set, accessibilities of respective items of the media content in the media content set by the second user.

In some examples, the change in the accessibility of the media content itself may be due to the deletion of the media content or the modification of its settings. For example, if the media content has been marked as “non-existent” or “non-public” (including but not limited to “deleted by the author”, “set to private”, “visible only to some people” or removed from the shelves, etc.), the cached video cannot be presented in the content transfer panel. Further, in some cases, certain media content can be presented to the first user but cannot be presented to the second user. The accessibility of each user to the media content may be related to a variety of factors, including but not limited to the user's login status, user-specific content filtering settings, etc. Therefore, when presenting the content transfer panel, it is necessary to consider whether the media content cached at the first terminal device is accessible to the second user. Considering that the first user wants to transmit the cached media content to the second user, the media content accessible to the second user is presented in the optional media content list.

In some embodiments, user 110-1 can select media content to be transmitted from the selectable media content list. In example interface 300F shown in FIG. 3F, user 110-1 can select part of the media content to be transmitted from the selectable media content list. User 110-1 can also click on a “select all” control 361 to select all media content from the media content list.

In some embodiments, the content transfer panel also includes a user identification of the first user and a user identification of the second user. Referring back to the example interface 300C shown in FIG. 3C, the content transfer panel 330 also includes a user identification 332 of user 110-1 (e.g., user 123) and a user identification 333 of user 110-2 (e.g., user 234). In some embodiments, the content transfer panel also includes a selection confirmation control. As shown in FIG. 3C, the content transfer panel 330 also includes a selection confirmation control (e.g., a transfer control) 331. If the user clicks the selection confirmation control 331, the selected content media is transferred to another user's terminal device. In some embodiments, the selection confirmation control displayed by the terminal device includes the total number of currently selected items of the content, such as 28. If the total number of selected items of content exceeds a threshold, “+” is displayed after the threshold. For example, if the total number of selected items of content exceeds 99, 99+ is displayed.

In some embodiments, the selection confirmation control will be presented in different states according to the transmission status of the media content (before transmission, during transmission, after transmission). As shown in the example interfaces 300C to 300D and 300E in FIGS. 3C-3D and FIG. 3E, when the selected media content is in the state of ‘before transmission’, the selection confirmation control 331 is in a clickable state, that is, the user 110-1 can click the selection confirmation control 331 to transmit the selected content media. When the selected media content is in the process of transmission, the selection confirmation control 331 is switched to a transmission progress bar. The selection confirmation control 331 presented as a transmission progress bar will be described in detail below.

When the selected media content is in the process of being transmitted, the selection confirmation control 331 is presented as a selection confirmation control 351 in a grayed-out state. After the transmission is completed, if the user clicks the selection confirmation control 351, the terminal device 120-1 will present a prompt message “All content has been transmitted”. In the example interface 300F shown in FIG. 3F, if no items of the media content in the media content list are selected, the selection confirmation control 331 is presented as a selection confirmation control 372 in a grayed-out state. At this time, if the user 110-1 clicks the selection confirmation control 372, the terminal device 120-1 will present a prompt message “Please select media content before transmission”

The following will describe in detail the case where the selection confirmation control 331 is presented as a transmission progress bar.

In some embodiments, during the process of transmitting one or more items of the media content from the first terminal device to the second terminal device, the terminal device 120-1 will present a first transmission progress indication of the one or more items of the media content. In some embodiments, the transmission progress indication includes a separate transmission progress bar. As shown in FIGS. 3C-3D, the previous confirmation selection control 331 is configured as a transmission progress bar 341. The transmission progress bar can linearly fill the button area according to the proportion of the transmission completion of the media content.

In some embodiments, alternatively or additionally, from the perspective of user 110-1 (i.e., the sender), the transmission progress indication may also include a transmission progress bar presented in association with the user identification of user 110-2 (i.e., the receiver). For example, a circular or other shaped progress bar 342 may be presented around the user identification (e.g., the user avatar) of user 110-2, and the progress bar may also be filled linearly according to the proportion of the transmission completion of the media content. Alternatively, or additionally, from the perspective of user 110-2 (i.e., the receiver), the transmission progress indication may also include a transmission progress bar presented in association with the user identification of user 110-1 (i.e., the sender). As shown in the example interface 400A of FIG. 4A, a circular or other shaped progress bar 412 may be presented around the user identifier (e.g., the user avatar) of user 110-1, and the progress bar may also be filled linearly according to the proportion of the transmission completion of the media content.

In some embodiments, the terminal device 120-1 may also receive one or more items of second media content from the terminal device 120-2 via a near field communication connection. The one or more items of the second media content are cached at the terminal device 120-2. After the terminal device 120-1 receives the one or more items of the second media content from the terminal device 120-2, if a content viewing request is detected, the received one or more items of the second media content are played.

In some examples, after a near field communication connection is established between terminal device 120-1 and terminal device 120-2, the two terminal devices can transmit content cached therein to each other. For example, the two terminal devices can transmit content to each other at different times, or they can transmit content to each other at the same time. The present disclosure is not limited to this. In some embodiments, during the transmission of one or more items of the second media content from terminal device 120-2 to terminal device 120-1, a second progress indication of the one or more items of the second media content is provided.

When terminal device 120-1 and terminal device 120-2 simultaneously send and receive content, the terminal devices provide a transmission progress indication. Whether from the perspective of user 110-1 (i.e., the sender) or user 110-2 (i.e., the receiver), the transmission progress indication may also include a transmission progress bar presented in association with the user identification of user 110-2 (i.e., the receiver) and a transmission progress bar presented in association with the user identification of user 110-1 (i.e., the sender).

FIG. 4E shows a schematic diagram of an example interface 400E for content interaction at a first terminal device and a second terminal device according to some embodiments of the present disclosure. As shown in the example interface 400E in FIG. 4E, a progress bar 452 in a ring or other shape may be presented around the user identification (e.g., user avatar) of the user 110-2, and a progress bar 453 in a ring or other shape may be presented around the user identification (e.g., user avatar) of the user 110-1.

It should be understood that the above only provides several example progress indicators for indicating the progress of the transmission. In actual applications, other progress indicators may be configured according to specific circumstances, which are not presented here one by one.

In some embodiments, during the transmission of one or more items of the media content from the first terminal device to the second terminal device and/or during the transmission of one or more items of the second media content from the second terminal device to the first terminal device, if the terminal device receives a request to exit the transmission, the near field communication connection is disconnected. If the near field communication connection is disconnected, the terminal device stops transmitting the media content that has not been sent to the other terminal device and/or stops receiving the media content from the other terminal device.

In some examples, if the user clicks the “Cancel” control 345 in the content transfer panel 330, the near field communication connection between the terminal device 120-1 and the terminal device 120-2 is disconnected. If the transmission is in progress at this time, the transmission is terminated and a prompt message “Transmission terminated” is presented. Accordingly, the terminal device presents a confirmation pop-up window to prompt the user whether to terminate the near field communication connection. If the user clicks the “Confirm” control in the confirmation pop-up window, the near field communication connection between the terminal device 120-1 and the terminal device 120-2 is disconnected.

In other examples, if the user triggers the “return” logic of certain systems (e.g., Android system), then “return to the previous step”. If it is in the transmission state at this time, the transmission is terminated, and a prompt message is presented: “Transmission terminated”. If it is in the connection state (i.e., non-transmission state) currently, the terminal device presents a confirmation pop-up window to prompt the user whether to terminate the near field communication connection. If the user clicks the “Confirm” control in the confirmation pop-up window, the near field communication connection between terminal device 120-1 and terminal device 120-2 is disconnected. In some examples, if the user does not actively cancel the disconnection during the transmission and connection process and a “connection interruption” occurs, a prompt message is presented: “Connection disconnected”.

The following continues to describe the solutions for content interaction disclosed in the present disclosure from the perspective of terminal device 120-2.

In some embodiments, the terminal device 120-2 can establish a near field communication connection between the terminal device 120-2 and the user 110-1 based on the user 110-1 using the terminal device 120-1 to scan the corresponding visual coding information, or the user 110-2 uses the terminal device 120 to scan the corresponding visual coding information of the terminal device 110-1, so as to establish a near field communication connection between the terminal device 120-2 and the terminal device 120-1. In some embodiments, the communication connection between the terminal device 120-2 and the terminal device 120-1 can also be established in the following manner.

If the terminal device 120-2 receives a request from the terminal device 120-1 corresponding to the user 110-1, the notification message is presented to indicate the content transfer request of the first user. As shown in the example interfaces 600A to 600B of FIGS. 6A-6B, when the user 110-1 (i.e., the sender) clicks the identification information 612 of the user 110-2 at the terminal device 120-1, the terminal device 120-2 receives the request from the terminal device 120-1 corresponding to the user 110-1 (e.g., the user 123). Accordingly, the terminal device 120-2 presents the notification message 621.

In some embodiments, if the terminal device 120-2 receives confirmation of the content transfer request, a near field communication connection is established between the terminal device 120-2 and the terminal device 120-1. As shown in FIG. 6B, if the terminal device 120-2 receives a trigger for the “receive” control 622 by the user 110-2, a near field communication connection is established between the terminal device 120-2 and the terminal device 120-1, and the transmission process is entered. In some examples, if the user 110-2 clicks the “reject” control, the terminal device 120-1 of the user 110-1 (i.e., the sender) presents a prompt message “Your request is rejected”.

In some embodiments, after the near field communication connection is established, the terminal device 120-2 presents a content transfer panel. As shown in the example interface 400A of FIG. 4A, after the near field communication connection is established, the terminal device 120-2 presents a content transfer panel 410. In some embodiments, if the terminal device 120-2 detects that the reception of one or more items of the media content is completed, thumbnails of the received one or more items of the media content are presented in the content transfer panel. As shown in the example interface 400B of FIG. 4B, after receiving one or more items of the media content, the terminal device 120-2 presents a thumbnail 421 of, for example, media content A in the content transfer panel 410.

In some embodiments, after receiving one or more items of the media content, the progress bar 412 in a ring or other shape surrounding the user identification (e.g., the user avatar) of the user 110-1 presented on the content transfer panel 410 of the terminal device 120-2 will also switch to a progress bar 422 indicating the completion of the transmission.

In some embodiments, if the terminal device 120-2 detects that the reception of one or more items of the media content is completed, it can also present a cache viewing entry in the content transfer panel. As shown in the example interface 400B of FIG. 4B, if the terminal device 120-2 detects that the reception of one or more items of the media content is completed, it can also present a cache viewing entry 423 in the content transfer panel 410. In some embodiments, the cache viewing entry 423 is displayed with the information “My data-traffic content +N”. In some examples, “+N” indicates the total number of items of the media content received by the terminal device 120-2 this time. In some embodiments, at the terminal device 120-2, the media content list can be updated, and the currently received media content is displayed in front of the media content list. In some embodiments, for the first time a user receives media content, the terminal device 120-2 presents guidance information for viewing the media content (e.g., “click to view”) in the area associated with the cache viewing entry.

In some embodiments, if the terminal device 120-2 detects a trigger for the cache viewing entry, a content viewing request is detected. Subsequently, if the terminal device 120-2 detects a content viewing request, at least one item of the media content among the received one or more items of the media content are played. As shown in the example interfaces 400B to 400C of FIGS. 4B-4C, if the user 110-2 clicks on the cache viewing entry 423, the “data-free content” page 430 is entered to view at least one item of the media content.

In some embodiments, if the terminal device 120-2 determines that at least one of the received one or more items of the media content is the same as the media content cached by the application at the second terminal device, the received at least one item of the media content is deleted. In some examples, if there is at least one item of the media content that is repeated with the media content cached by the terminal device 120-2, the redundant newly transmitted at least one item of the media content can be deleted, and the items of the media content that have not been cached are retained.

In some embodiments, if the received one or more items of the media content are all presented, the terminal device 120-2 presents a first prompt message. The first prompt message includes at least one of the following: a presentation completion indication, a data saving indication, and a continued browsing indication for the received media content. In some embodiments, the presentation completion indication is an indication indicating that the received media content is all presented. The data saving indication is an indication indicating that the total data corresponding to the one or more items of the media content is saved. The continued browsing indication for the received media content is an indication indicating that the user 110-2 can continue browsing the received media content.

As shown in the example interface 400D of FIG. 4D, if the one or more items of the media content received by the terminal device 120-2 are browsed by the user 110-2, the terminal device 120-2 may present a first prompt message on the first viewed video. For example, a completion indication 441 (e.g., “You have finished watching all the data-free videos”) is presented. For example, a data saving indication 442 (e.g., “Save you data by XX amount”) is presented, indicating the total size of the “unviewed (new) media content” that the user 110-2 has browsed and consumed in the data-free content library.

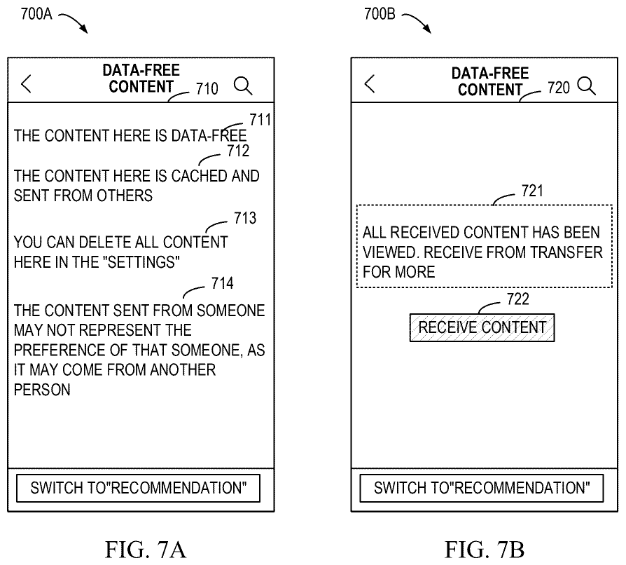

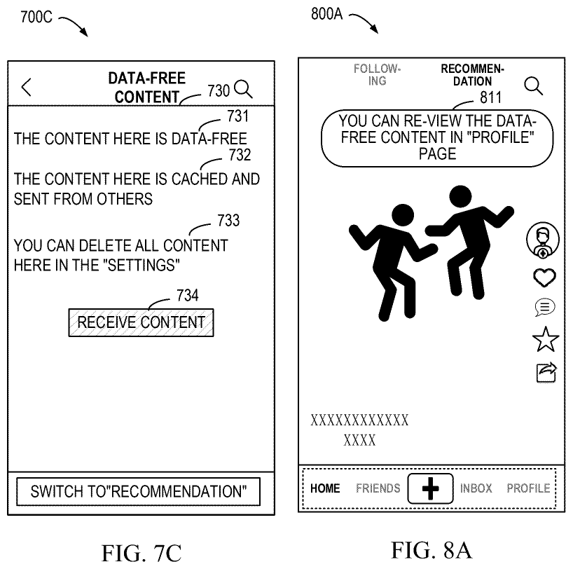

As shown in FIG. 4C, the terminal device 120-2 may also present a “switch to a recommendation page” control 431 in the page corresponding to the data-free content. The user 110-2 may click the “switch to a recommendation page” control 431 to switch to the recommendation page (also referred to as the “home page”). In some embodiments, the terminal device 120-2 may also present an information explanation entry in the page corresponding to the data-free content. Alternatively, the terminal device 120-2 may also present an information explanation entry in a predetermined page (e.g., a personal homepage). That is, after the user 110-2 clicks the information explanation entry, the terminal device 120-2 may present a data-saving mode function page (also referred to as an “information explanation page”). FIGS. 7A-7C show schematic diagrams of example interfaces 700A to 700C for presenting a data-saving mode function page according to some embodiments of the present disclosure.

As shown in the example interface 700A of FIG. 7A, if the user 110-2 clicks on the information explanation entry presented in the corresponding page of the data-free content, the information explanation page 710 presented by the terminal device 120-2 includes a scene introduction 711, a media content source reception 712, a content clearing introduction 713, a content privacy introduction 714, a suffix-“Note: Reading and posting comments will consume your data”, etc. In this case, the user 110-2 can swipe up to continue viewing the cached video.

As shown in the example interface 700B of FIG. 7B, after watching the received media content, if the user 110-2 clicks on the information explanation entry presented in the personal homepage, the information explanation page 720 presented by the terminal device 120-2 includes a scene prompt 721 “All content has been watched XXX”. The information explanation page 720 may also include a “receive content” control 722 to restart the transmission of new media content based on the near field communication connection. In this case, the user 110-2 can swipe up to continue viewing the cached video.

As shown in the example interface 700C of FIG. 7C, if the user 110-2 clicks on the information explanation entry presented in the personal homepage without receiving the media content through the near field transmission, the information explanation page 730 presented by the terminal device 120-2 includes a scene introduction 731, a media content source reception 732, and a content clearing introduction 733. The information explanation page 730 may also include a “receive content” control 734 to enable the transmission of media content based on the near field communication connection. In this case, as shown in the example interface 500A of FIG. 5A, if the user 110-2 returns to the “recommendation page”, the terminal device 120-2 presents a bubble guidance 512-“can be used to transmit media content” for the sharing entry.

In some embodiments, the terminal device 120-2 may also play at least one of the received one or more items of the media content based on the following operations. In some embodiments, when a predetermined page of an application is presented, the terminal device 120-2 presents a cache viewing entry in the predetermined page. If the terminal device 120-2 detects a trigger for the cache viewing entry, a content viewing request is detected. Subsequently, if the terminal device 120-2 detects a content viewing request, it plays at least one of the received one or more items of the media content. FIGS. 8A-8C show schematic diagrams of example interfaces 800A to 800C for content interaction based on a predetermined page according to some embodiments of the present disclosure.

As shown in the example interface 800B of FIG. 8B, the user 110-2 can click on the “Me” control 822 to enter the predetermined page (sometimes also referred to as a personal homepage) 820. The terminal device 120-2 can present a cache viewing entry 821 in the predetermined page 820, and the user can view the received one or more items of the media content by clicking on the cache viewing entry 821. In some examples, if the user 110-2 has received the media content sent by the other party but does not click on the cache viewing entry 821 after entering the personal homepage, the terminal device 120-2 presents a guidance message 823 to prompt the user 120-2 to click on the cache viewing entry 821 to view the media content without consuming data.

As shown in the example interface 800A of FIG. 8A, when the user 110-2 receives the media content transmitted from the other party for the first time and has not entered the predetermined page 820, if the user 110-2 is on the “recommendation page” at this time, the terminal device 120-2 presents a prompt message 811 on the “recommendation page” to guide the user 110-2 to view the received media content on the predetermined page 820.

In some embodiments, on the predetermined page, the terminal device 120-2 presents an unviewed indicator in association with a cache viewing entry. In some embodiments, the unviewed indicator indicates unviewed media content received from other terminal devices other than the second terminal device. As shown in the example interface 800C of FIG. 8C, if there is newly received unviewed media content and the unviewed media content has not been accessed, the terminal device 120-2 presents an unviewed indicator 831 (e.g., the number of items of the unviewed media content).

In summary, the present disclosure can enable users to transfer cached media content based on a near field communication connection, so that both parties can experience new and data-free media content that can be viewed. Furthermore, since the exchanged content media does not need to be downloaded again, the user's need for data-free viewing is achieved, thereby improving the active duration and retention of the application.

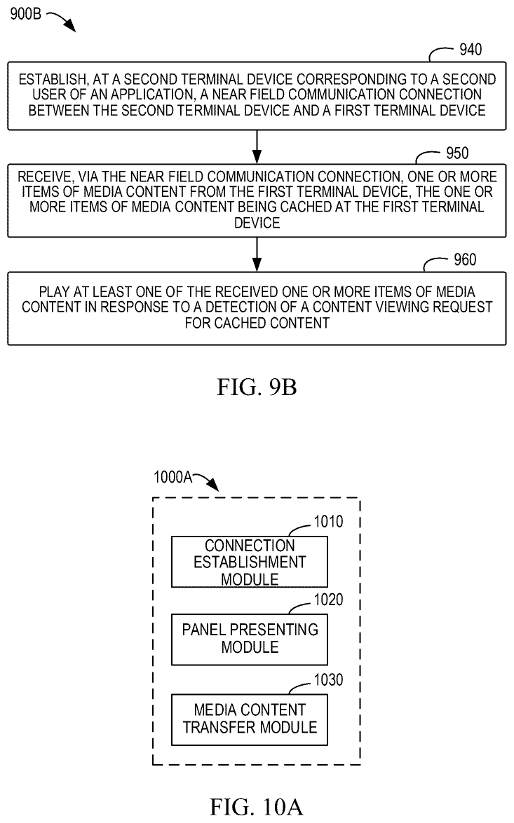

FIG. 9A shows a flow chart of a process 900A for content interaction according to some embodiments of the present disclosure. Process 900A may be implemented at any terminal device 120, such as at terminal device 120-1. Process 900A is described below with reference to FIG. 1.

At block 910, terminal device 120-1, at a first terminal device corresponding to a first user of an application, establishes a near field communication connection between the first terminal device and a second terminal device corresponding to the second user in response to a detection of a content transfer request for a second user of the application.

At block 920, terminal device 120-1 presents a content transfer panel, which presents a media content list cached by the application at the first terminal device.

At block 930, terminal device 120-1 transmits one or more items of the media content from the first terminal device to the second terminal device via a near field communication connection in response to receiving a selection of one or more items of the media content in the media content list.

In some embodiments, process 900A further includes: in response to a detection of a trigger for a content transfer entry, presenting a user selection panel, the user selection panel including at least one of the following: a scanning window for scanning visual coding information, first visual coding information corresponding to the first user, and user identifications of one or more users in the application; and detecting of a content transfer request for a second user via the user selection panel.

In some embodiments, presenting the user selection panel includes determining one or more terminal devices located within a predetermined geographical range of the first terminal device, the one or more terminal devices being configured with permissions to be discovered by surrounding devices; and presenting user identifications of one or more users corresponding to the one or more terminal devices in the user selection panel.

In some embodiments, presenting the user selection panel includes: in response to a detection of a trigger for a content transfer entry, determining whether to obtain permission(s) to use one or more functions in the first terminal device; in response to a determination that permission(s) to use at least one of the one or more functions is not obtained, presenting an authorization panel, the authorization panel at least indicating an enablement control for permission(s) to use at least one function; and in response to a determination that permission(s) to use one or more functions in the first terminal device is obtained, presenting the user selection panel.

In some embodiments, the one or more functions include at least one of the following: a function of reading and writing files, a function for supporting near field communication, and a camera function.

In some embodiments, presenting the content transfer panel includes determining a media content list to be presented in the content transfer panel from a media content set cached by the application at the first terminal device based on at least one of the following: accessibilities of respective items of the media content in the media content set, accessibilities of respective items of the media content in the media content set by the second user.

In some embodiments, transmitting one or more items of the media content from the first terminal device to the second terminal device includes: providing a first transmission progress indication of the one or more items of the media content during the transmission of the one or more items of the media content from the first terminal device to the second terminal device.

In some embodiments, process 900A also includes receiving one or more items of second media content from the second terminal device via a near field communication connection, the one or more items of the second media content being cached at the second terminal device; and in response to a detection of a content viewing request, playing at least one of the received one or more items of the second media content.

In some embodiments, process 900A also includes providing a second transmission progress indication of the one or more items of the second media content during the transmission of the one or more items of the second media content from the second terminal device to the first terminal device.

In some embodiments, process 900A also includes: during the transmission of one or more items of the media content from the first terminal device to the second terminal device and/or during the transmission of one or more items of the second media content from the second terminal device to the first terminal device, in response to receiving a request to exit the transmission, disconnecting the near field communication connection; in response to a disconnection of the near field communication connection, stopping the transmission of media content that have not been sent to the second terminal device and/or stopping the reception of media content from the second terminal device.

In some embodiments, process 900A also includes in response to a determination that the first user and the second user have not established a predetermined social relationship, providing prompt information to instruct the first user to initiate establishment of a predetermined social relationship with the second user.

FIG. 9B shows a flow chart of a process 900B for content interaction according to some embodiments of the present disclosure. The process 900B can be implemented at any terminal device 120, for example, at the terminal device 120-2. The process 900B is described below with reference to FIG. 1.

At block 940, the terminal device 120-2 establishes a near field communication connection between the second terminal device and the first terminal device at the second terminal device corresponding to the second user of the application.

At block 950, the terminal device 120-2 receives one or more items of media content from the first terminal device via the near field communication connection, and the one or more items of the media content is cached at the first terminal device.

At block 960, the terminal device 120-2 plays at least one of the received one or more items of the media content in response to a detection of a content viewing request for the cached content.

In some embodiments, establishing a near field communication connection between the second terminal device and the first terminal device includes: in response to a request from the first terminal device corresponding to the first user of the application, presenting a notification message to indicate the content transfer request of the first user; in response to receiving a confirmation of the content transfer request, establishing a near field communication connection between the second terminal device and the first terminal device.

In some embodiments, process 900B further includes in response to the establishment of the near field communication connection, presenting a content transfer panel; and in response to the completion of the reception of the one or more items of the media content, presenting thumbnails of the received one or more items of the media content in the content transfer panel.

In some embodiments, playing at least one of the received one or more items of the media content includes: in response to the completion of the reception of the one or more items of the media content, presenting a cache viewing entry in the content transfer panel; in response to a detection of a trigger for the cache viewing entry, a content viewing request is detected; and in response to a detection of the content viewing request, playing at least one of the received one or more media content.

In some embodiments, process 900B further includes in response to a determination that at least one of the received one or more items of the media content is the same as the media content cached by the application at the second terminal device, deleting the received at least one media content.

In some embodiments, process 900B also includes presenting a first prompt message in response to a presentation of the received one or more items of the media content, the first prompt message including at least one of the following: a presentation completion indication to indicate that all received media contents are presented, a traffic saving indication to indicate that the total traffic corresponding to one or more media contents is saved, and an indication to continue browsing the received media contents.

In some embodiments, playing at least one of the received one or more items of the media content includes: in response to a presentation of a predetermined page of an application, presenting a cache viewing entry on the predetermined page; in response to a detection of a trigger for the cache viewing entry, a content viewing request is detected; and in response to a detection of the content viewing request, playing at least one of the received one or more items of the media content.

In some embodiments, process 900B further includes presenting an unviewed indicator in association with the cache viewing entry on the predetermined page, the unviewed indicator indicating unviewed media content received from other terminal devices other than the second terminal device.

In some embodiments, process 900B further includes in response to a determination that the second user has not established a predetermined social relationship with the first user, providing a second prompt message to instruct the second user to initiate the establishment of a predetermined social relationship with the first user.

### Example Apparatus and Apparatus

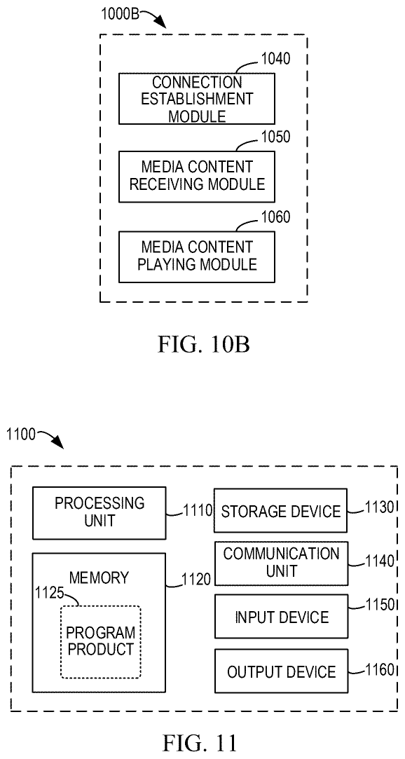

Embodiments of the present disclosure also provide a corresponding apparatus for implementing the above method or process. FIG. 10A shows a schematic structural block diagram of an apparatus 1000A for content interaction according to some embodiments of the present disclosure. The apparatus 1000A may be implemented or included in the terminal device 120-1. The various modules/components in the apparatus 1000A may be implemented by hardware, software, firmware, or any combination thereof.

As shown in FIG. 10A, the apparatus 1000A includes a connection establishment module 1010 configured to, at a first terminal device corresponding to a first user of an application, establish a near field communication connection between the first terminal device and a second terminal device corresponding to the second user in response to a detection of a content transfer request of a second user of the application. The apparatus 1000A further includes a panel presentation module 1020 configured to present a content transfer panel presenting a media content list cached at the first terminal device. The apparatus 1000A further includes a media content transfer module 1030 configured to transmit the one or more items of the media content from the first terminal device to the second terminal device via the near field communication connection in response to receiving a selection of one or more items of the media content in the media content list.

In some embodiments, the apparatus 1000A further includes a request detection module, configured to present a user selection panel in response to a detection of a trigger for a content transfer entry, the user selection panel including at least one of the following: a scanning window for scanning visual coding information, first visual coding information corresponding to the first user, and user identifications of one or more users in the application; and detecting a content transfer request for the second user via the user selection panel.

In some embodiments, the panel presentation module 1020 is further configured to determine one or more terminal devices located within a predetermined geographical range of the first terminal device, the one or more terminal devices being configured with permissions to be discovered by surrounding devices; and presenting the user identifications of one or more users corresponding to the one or more terminal devices in the user selection panel.

In some embodiments, the panel presentation module 1020 is further configured to, in response to a detection of a trigger for a content transfer entry, determine whether to obtain permission(s) to use one or more functions in the first terminal device; in response to a determination that that permission(s) to use at least one of the one or more functions is not obtained, present an authorization panel, the authorization panel at least indicating an enabling control for permission(s) to use at least one function; and in response to a determination that permission(s) to use the one or more functions in the first terminal device is obtained, present a user selection panel.

In some embodiments, the one or more functions include at least one of the following: a function of reading and writing files, a function for supporting near field communication, and a camera function.

In some embodiments, the media content transfer module 1030 is further configured to determine a media content list presented in the content transfer panel from a media content set cached by the application at the first terminal device based on at least one of the following: accessibilities of respective items of the media content in the media content set, accessibilities of respective items of the media content in the media content set by the second user.

In some embodiments, the media content transfer module 1030 is further configured to provide a first transmission progress indication of one or more items of the media content during the transmission of one or more items of the media content from the first terminal device to the second terminal device.

In some embodiments, the apparatus 1000A further includes a content playback module configured to receive one or more items of second media content from the second terminal device via a near field communication connection, the one or more items of the second media content being cached at the second terminal device; and in response to a detection of a content viewing request, play at least one of the received one or more items of the second media content.

In some embodiments, the apparatus 1000A further includes an indication providing module configured to provide a second transmission progress indication of one or more items of the second media content during the transmission of one or more items of the second media content from the second terminal device to the first terminal device.

In some embodiments, the device 1000A also includes a stop transmission module, which is configured to disconnect the near field communication connection in response to receiving a transmission exiting request during the transmission of one or more items of the media content from the first terminal device to the second terminal device and/or during the transmission of one or more items of the second media content from the second terminal device to the first terminal device; in response to a disconnection of the near field communication connection, stop transmitting the media content that has not been sent to the second terminal device and/or stop receiving the media content from the second terminal device.

In some embodiments, the device 1000A also includes an information providing module, which is configured to provide prompt information in response to a determination that the first user and the second user have not established a predetermined social relationship, to instruct the first user to initiate the establishment of a predetermined social relationship with the second user.

The units and/or modules included in the device 1000A can be implemented in various ways, including software, hardware, firmware, or any combination thereof. In some embodiments, one or more units and/or modules can be implemented using software and/or firmware, such as machine executable instructions stored on a storage medium. In addition to or as an alternative to machine executable instructions, some or all of the units and/or modules in the device 1000A can be implemented at least in part by one or more hardware logic components. By way of example and not limitation, example types of hardware logic components that can be used include field programmable gate arrays (FPGAs), application specific integrated circuits (ASICs), application specific standard products (ASSPs), system on a chip (SOCs), complex programmable logic devices (CPLDs), and the like.

It should be understood that one or more steps in the above method may be performed by an appropriate electronic device or a combination of electronic devices. Such an electronic device or a combination of electronic devices may include, for example, the terminal device 120 in FIG. 1.

Embodiments of the present disclosure also provide corresponding devices for implementing the above-mentioned methods or processes. FIG. 10B shows a schematic structural block diagram of a device 1000B for content interaction according to some embodiments of the present disclosure. The device 1000B may be implemented as or included in the terminal device 120-2. Each module/component in the device 1000B may be implemented by hardware, software, firmware, or any combination thereof.

As shown in FIG. 10B, the device 1000B includes a connection establishment module 1040, which is configured to establish a near field communication connection between the second terminal device and the first terminal device at the second terminal device corresponding to the second user of the application. The device 1000B also includes a media content receiving module 1050, which is configured to receive one or more items of media content from the first terminal device via the near field communication connection, and the one or more items of the media content is cached at the first terminal device. The device 1000B also includes a media content playing module 1060, which is configured to play at least one of the received one or more items of the media content in response to a detection of a content viewing request for the cached content.

In some embodiments, the connection establishment module 1040 is further configured to present a notification message in response to a request from a first terminal device corresponding to a first user of the application to indicate a content transfer request of the first user; and to establish a near field communication connection between the second terminal device and the first terminal device in response to receiving a confirmation of the content transfer request.

In some embodiments, the apparatus 1000B further includes a thumbnail presentation module, configured to present a content transfer panel in response to the establishment of a near field communication connection; and to present thumbnails of the received one or more items of the media content in the content transfer panel in response to the completion of receiving one or more media contents.

In some embodiments, the media content playback module 1060 is further configured to present a cache viewing entry in the content transfer panel in response to the completion of receiving one or more items of the media content; to detect a content viewing request in response to a detection of a trigger for the cache viewing entry; and to play at least one of the received one or more items of the media content in response to a detection of a content viewing request.

In some embodiments, the device 1000B further includes a media content deletion module, configured to delete the received at least one items of the media content in response to a determination that at least one of the received one or more items of media content is the same as the media content cached by the application at the second terminal device.

In some embodiments, the device 1000B further includes a prompt information presentation module, configured to present a first prompt information in response to a presentation of the received one or more items of the media content, the first prompt information including at least one of the following: a presentation completion indication to indicate that the received media content has been presented, a data saving indication to indicate that the total data corresponding to the one or more items of the media content is saved, and a continue browsing indication for the received media content.

In some embodiments, the media content playback module 1060 is further configured to present a cache viewing entry on a predetermined page in response to a presentation of a predetermined page of an application; detect a content viewing request in response to a detection of a trigger for the cache viewing entry; and play at least one of the received one or more items of the media content in response to a detection of the content viewing request.

In some embodiments, the device 1000B further includes an indicator presentation module configured to present an unviewed indicator on a predetermined page in association with the cache viewing entry, the unviewed indicator indicating unviewed media content received from other terminal devices other than the second terminal device.

In some embodiments, the prompt information presentation module is further configured to provide a second prompt information in response to a determination that the second user has not established a predetermined social relationship with the first user, to indicate that the second user initiates the establishment of a predetermined social relationship with the first user.

The units and/or modules included in the device 1000B may be implemented in various ways, including software, hardware, firmware, or any combination thereof. In some embodiments, one or more units and/or modules may be implemented using software and/or firmware, such as machine executable instructions stored on a storage medium. In addition to or as an alternative to machine executable instructions, some or all of the units and/or modules in the device 1000B may be implemented at least in part by one or more hardware logic components. As an example, and not a limitation, example types of hardware logic components that may be used include field programmable gate arrays (FPGAs), application specific integrated circuits (ASICs), application specific standard products (ASSPs), systems on chips (SOCs), complex programmable logic devices (CPLDs), and the like.

It should be understood that one or more steps in the above method can be performed by an appropriate electronic device or combination of electronic devices. Such an electronic device or combination of electronic devices may, for example, include the terminal device 120 in FIG. 1.

FIG. 11 shows a block diagram of an electronic device 1100 in which one or more embodiments of the present disclosure may be implemented. It should be understood that the electronic device 1100 shown in FIG. 11 is merely an example and should not constitute any limitation on the functionality and scope of the embodiments described herein. The electronic device 1100 shown in FIG. 11 may be used to implement the terminal device 110 of FIG. 1.

As shown in FIG. 11, the electronic device 1100 is in the form of a general electronic device. The components of the electronic device 1100 may include, but are not limited to, one or more processors or processing units 1110, a memory 1120, a storage device 1130, one or more communication units 1140, one or more input devices 1150, and one or more output devices 1160. The processing unit 1110 may be an actual or virtual processor and may be capable of performing various processes according to a program stored in the memory 1120. In a multi-processor system, multiple processing units execute computer executable instructions in parallel to increase the parallel processing capabilities of the electronic device 1100.

The electronic device 1100 typically includes multiple computer storage media. Such media can be any available media accessible to the electronic device 1100, including but not limited to volatile and non-volatile media, removable and non-removable media. The memory 1120 can be a volatile memory (e.g., registers, cache, random access memory (RAM)), a non-volatile memory (e.g., read-only memory (ROM), electrically erasable programmable read-only memory (EEPROM), flash memory), or some combination thereof. The storage device 1130 can be a removable or non-removable medium and can include a machine-readable medium such as a flash drive, a disk, or any other medium that can be used to store information and/or data and can be accessed within the electronic device 1100.

The electronic device 1100 can further include additional removable/non-removable, volatile/non-volatile storage media. Although not shown in FIG. 11, a magnetic disk drive for reading or writing from a removable, nonvolatile magnetic disk (e.g., a “floppy disk”) and an optical disk drive for reading or writing from a removable, nonvolatile optical disk may be provided. In these cases, each drive may be connected to the bus (not shown) by one or more data media interfaces. The memory 1120 may include a computer program product 1125 having one or more program modules that are configured to perform various methods or actions of various embodiments of the present disclosure.

The communication unit 1140 enables communication with other electronic devices via a communication medium. Additionally, the functions of the components of the electronic device 1100 may be implemented in a single computing cluster or multiple computing machines that are capable of communicating via a communication connection. Thus, the electronic device 1100 may operate in a networked environment using a logical connection with one or more other servers, a network personal computer (PC), or another network node.

The input device 1150 may be one or more input devices, such as a mouse, a keyboard, a trackball, etc. The output device 1160 may be one or more output devices, such as a display, a speaker, a printer, etc. The electronic device 1100 may also communicate with one or more external devices (not shown) such as a storage device, a display device, etc., one or more devices that enable a user to interact with the electronic device 1100, or any device that enables the electronic device 1100 to communicate with one or more other electronic devices (e.g., a network card, a modem, etc.) via the communication unit 1140 as needed. Such communication may be performed via an input/output (I/O) interface (not shown).

According to an example embodiment of the present disclosure, a computer-readable storage medium is provided, on which computer-executable instructions are stored, where the computer-executable instructions are executed by a processor to implement the method described above. According to an example embodiment of the present disclosure, a computer program product is also provided, which is tangibly stored on a non-transitory computer-readable medium and includes computer-executable instructions, and the computer-executable instructions are executed by a processor to implement the method described above.

Various aspects of the present disclosure are described herein with reference to flowcharts and/or block diagrams of methods, apparatuses, devices, and computer program products implemented according to the present disclosure. It should be understood that each block of the flowchart and/or block diagram, and the combination of blocks in the flowchart and/or block diagram, can be implemented by computer-readable program instructions.

These computer-readable program instructions can be provided to a processing unit of a general-purpose computer, a special-purpose computer, or other programmable data processing device, thereby producing a machine such that when these instructions are executed by the processing unit of the computer or other programmable data processing device, a device that implements the functions/actions specified in one or more blocks in the flowchart and/or block diagram is generated. These computer-readable program instructions may also be stored in a computer-readable storage medium, which enables a computer, a programmable data processing device and/or other equipment to operate in a specific manner, so that the computer-readable medium storing the instructions includes a manufactured product, which includes instructions for implementing various aspects of the functions/actions specified in one or more boxes in the flowchart and/or block diagram.

Computer-readable program instructions may be loaded onto a computer, other programmable data processing device, or other device so that a series of operational steps are executed on the computer, other programmable data processing device, or other device to produce a computer-implemented process, so that the instructions executed on the computer, other programmable data processing device, or other device implement the functions/actions specified in one or more blocks in the flowchart and/or block diagram.

The flowcharts and block diagrams in the accompanying drawings illustrate possible architectures, functions, and operations of systems, methods, and computer program products according to multiple implementations of the present disclosure. In this regard, each block in the flowchart or block diagram may represent a module, program segment, or portion of an instruction, which contains one or more executable instructions for implementing the specified logical functions. In some alternative implementations, the functions marked in the blocks may also occur in an order different from that marked in the accompanying drawings. For example, two consecutive blocks may actually be executed substantially in parallel, or they may sometimes be executed in reverse order, depending on the functions involved. It should also be noted that each box in the block diagram and/or flowchart, and the combination of boxes in the block diagram and/or flowchart, can be implemented by a dedicated hardware-based system that performs the specified function or action, or can be implemented by a combination of dedicated hardware and computer instructions.

The above description of various implementations of the present disclosure is example, not exhaustive, and is not limited to the disclosed implementations. Many modifications and changes will be apparent to those of ordinary skill in the art without departing from the scope and spirit of the described implementations. The terms used in this article are selected to best explain the principles of the implementations, practical applications, or improvements to the technology in the market, or to enable other ordinary skill in the art to understand the various embodiments disclosed herein.

I/We claim:

1. A method for content interaction, comprising:
establishing, at a first terminal device corresponding to a first user of an application, a near field communication connection between the first terminal device and a second terminal device corresponding to a second user of the application in response to a detection of a content transfer request for the second user;
presenting a content transfer panel, the content transfer panel presenting a media content list cached by the application at the first terminal device; and
transmitting one or more items of media content from the first terminal device to the second terminal device via the near field communication connection in response to receiving a selection of the one or more items of media content in the media content list.

2. The method of claim 1, further comprising:
presenting a user selection panel in response to a detection of a trigger for a content transfer entry, the user selection panel comprising at least one of the following:
a scanning window for scanning visual coding information,
first visual coding information corresponding to the first user,
one or more user identifications of one or more users of the application; and
detecting the content transfer request for the second user via the user selection panel.

3. The method of claim 1, wherein the presenting the user selection panel comprises:
determining one or more terminal devices located within a predetermined geographical range of the first terminal device, the one or more terminal devices being configured with a permission of allowing to be discovered by surrounding devices; and
presenting, in the user selection panel, one or more user identifications of the one or more users corresponding to the one or more terminal devices.

4. The method of claim 2, wherein the presenting the user selection panel comprises:
determining whether to obtain one or more permissions of using one or more functions in the first terminal device in response to a detection of a trigger for the content transfer entry;
presenting an authorization panel, the authorization panel at least indicating an enabling control for a permission of using at least one function of the one or more functions in response to a determination that the permission of using the at least one function is not obtained; and
presenting the user selection panel in response to a determination that the one or more permissions of using the one or more functions in the first terminal device has been obtained.

5. The method of claim 4, wherein the one or more functions comprise at least one of the following:
a function of reading and writing files,
a function for supporting near field communication, or
a camera function.

6. The method of claim 1, wherein the presenting the content transfer panel comprises:
determining the media content list presented in the content transfer panel from a media content set cached at the first terminal device by the application, based on at least one of the following:
accessibilities of respective items of media content in the media content set, or
accessibilities of respective items of media content in the media content set by the second user.

7. The method of claim 1, wherein the transmitting the one or more items of the media content from the first terminal device to the second terminal device comprises:
providing a first transmission progress indication of the one or more items of the media content during a transmission process of the one or more items of the media content from the first terminal device to the second terminal device.

8. The method of claim 1, further comprising:
receiving one or more items of second media content from the second terminal device via the near field communication connection, wherein the one or more items of second media content are cached at the second terminal device;
providing, in a transmission process of the one or more items of second media content from the second terminal device to the first terminal device, a second transmission progress indication of the one or more items of the second media content; and
playing at least one of the received one or more items of the second media content in response to a detection of a content viewing request.

9. The method of claim 1, further comprising:
in a transmission process of the one or more items of media content from the first terminal device to the second terminal device and/or in a transmission process of the one or more items of second media content from the second terminal device to the first terminal device,
disconnecting the near field communication connection in response to a reception of a transmission exiting request; and
terminating the transmitting of media content that has not yet been sent to the second terminal device and/or terminating the receiving of the media content from the second terminal device in response to a disconnection of the near field communication connection.

10. The method of claim 1, further comprising:
providing information to indicate establishment of a predetermined social relationship with the second user by the first user in response to a determination of no established predetermined social relationship between the first user and the second user.

11. A method for content interaction, comprising:
establishing, at a second terminal device corresponding to a second user of an application, a near field communication connection between the second terminal device and a first terminal device;
receiving, via the near field communication connection, one or more items of media content from the first terminal device, the one or more items of media content being cached at the first terminal device; and
playing at least one of the received one or more items of media content in response to a detection of a content viewing request for cached content.

12. The method of claim 11, wherein the establishing the near field communication connection between the second terminal device and the first terminal device comprises:
in response to a request from the first terminal device corresponding to a first user of the application, presenting a notification message to indicate a content transfer request of the first user; and
establishing the near field communication connection between the second terminal device and the first terminal device in response to the reception of a confirmation of the content transfer request.

13. The method of claim 11, further comprising:
presenting a content transfer panel in response to the establishment of the near field communication connection; and
presenting, at the content transfer panel, one or more thumbnails of the received one or more items of media content in response to a completion of the reception of the one or more items of media content.

14. The method of claim 13, wherein the playing at least one of the received one or more items of media content comprises:
presenting, at the content transfer panel, a cache viewing entry in response to a completion of the reception of the one or more items of media content;
detecting the content viewing request in response to a detection of a trigger for the cache viewing entry; and
playing at least one of the received one or more items of media content in response to a detection of the content viewing request.

15. The method of claim 11, further comprising:
deleting at least one of the one or more received items of media content in response to a determination that the at least one item of media content is the same as the media content cached by the application at the second terminal device.

16. The method of claim 11, further comprising:
presenting first prompt information in response to a presentation of the received one or more items of media content, the first prompt information including at least one of the following:
a presentation completion indication to indicate that the received media content has been presented,
a traffic saving indication to indicate that the total traffic corresponding to the one or more items of media content has been saved, and
an indication to indicate a continued browsing of the received media content.

17. The method of claim 11, wherein the playing at least one of the received one or more items of the media content comprises:
presenting the cache viewing entry on a predetermined page of the application in response to a presentation of the predetermined page;
detecting the content viewing request in response to a detection of a trigger for the cache viewing entry; and
playing at least one of the received one or more items of the media content in response to a detection of the content viewing request.

18. The method of claim 17, further comprising:
presenting an unviewed indicator in association with the cache viewing entry on the predetermined page, the unviewed indicator indicating unviewed media content received from terminal devices other than the second terminal device.

19. The method of claim 11, further comprising:
providing second prompt information to indicate the second user to initiate an establishment of a predetermined social relationship with the first user in response to a determination of no established predetermined social relationship between the second user and the first user.

20. An electronic device includes:
at least one processing unit; and
at least one memory coupled to the at least one processing unit and storing instructions for execution by the at least one processing unit, the instructions, when executed by the at least one processing unit, causing the electronic device to:
establishing, at the electronic device corresponding to a first user of an application, a near field communication connection between the electronic device and a second electronic device corresponding to a second user of the application in response to a detection of a content transfer request for the second user;
presenting a content transfer panel, the content transfer panel presenting a media content list cached by the application at the electronic device; and
transmitting one or more items of media content from the electronic device to the second electronic device via the near field communication connection in response to receiving a selection of the one or more items of media content in the media content list.
